(19) United States
(12) Patent Application Publication
(10) Pub. No.: US 2013/0098600 A1
(43) Pub. Date: Apr. 25, 2013

(54) Manufacturing Technique for a Composite Ball for Use Downhole in a Hydrocarbon Wellbore

(71) Applicant: TEAM Oil Tools LP, The Woodlands, TX (US)

(72) Inventor: William M. Roberts, Melbourne, AR (US)

(73) Assignee: TEAM Oil Tools LP, The Woodlands, TX (US)

(21) Appl. No.: 13/652,728

(22) Filed: Oct. 16, 2012

Related U.S. Application Data
(60) Provisional application No. 61/551,210, filed on Oct. 25, 2011.
(60) Provisional application No. 61/564,494, filed on Nov. 29, 2011.

(51) Int. Cl. E21B 33/12; B32B 37/02

(52) U.S. Cl. CPC E21B 33/12; B32B 37/02
USPC 166/193; 156/186

(57) ABSTRACT

A system and method for a composite ball for use downhole in a hydrocarbon wellbore, the composite ball having: a core; a fiber structure arranged around the core, wherein the fiber structure has non-uniform oriented fiber; and a resin within and encasing the fiber structure arranged around the core. A system and method for fabricating a composite ball for use downhole in a hydrocarbon wellbore, including arranging at least one fiber m a plurality of non-uniform orientations around a core; infusing a resin onto the at least one fiber arranged around the core; and forming a resin skin on the composite ball.

### CROSS-REFERENCE TO RELATED APPLICATIONS

The priority of U.S. Provisional Application Ser. No. 61/551,210, entitled. “Manufacturing Technique for Improving the Differential Pressure Capability of a Composite Ball for Use Downhole in a Hydrocarbon Wellbore”, and filed Oct. 25. 2011, in the name of the inventor William M. Roberts is hereby claimed under 35 U.S.C. §119(e). This application is also hereby incorporated by reference for all purposes as if expressly set forth verbatim herein.

The priority of U.S. Provisional Application Ser. No. 61/564,494, entitled “Manufacturing Technique for Improving the Differential Pressure Capability of a Composite Ball for Use Downhole in a Hydrocarbon Wellbore”, and filed Nov. 29, 2011, in the name of the inventor William M. Roberts is hereby claimed under 35 U.S.C. §119(e). This application is also hereby incorporated by reference for all purposes as if expressly set forth verbatim herein.

### STATEMENT REGARDING FEDERALLY SPONSORED RESEARCH OR DEVELOPMENT

Not applicable.

### BACKGROUND

This section of this document introduces various aspects of the art that may be related to various aspects of the technique described and/or claimed below. It provides background information to facilitate a better understanding of the various aspects of the presently disclosed technique. As the section's title implies, this is a discussion of “related” art. That such art is related in no way implies that it is also “prior” art. The related art may or may not be prior art. The discussion in this section of this document is to be read in this light, and not as admissions of prior art.

Well-completion activities in the production of hydrocarbons may use bails of various sizes to interact with or deliver force on tools down in the wellbore. Such a ball is generally introduced to the wellbore where forces act on the ball to push or pull it downhole until the ball “seats” on a tool of some kind. It is well known in the art that wellbores are seldom strictly vertical and that many, in fact, may extend horizontally (or near horizontally) substantially parallel to the wound surface for significant distances. Thus, gravity may only be one force acting on the balls. Conventional practice also typically calls for fluid pressure to be introduced to the wellbore that also acts on the ball.

These balls can be classed into at least two different classes: (1) metal balls; and (2) resin or composite balls. Metal balls are usually made from a relatively heavy, dense metal. Resin or composite balls are typically fabricated in one of two ways. They may be cast from a pure resin (e.g., phenolic resin), or machined from sheets of resin including resin-infused, stacked, and compressed sheets of woven fibers.

Unfortunately, conventional composite balls tend to be either brittle if cast from resin (e.g., phenolic resin) without reinforcing fiber, or mushy and weak at application temperature if made from stacked and compressed layers of woven fibers infused with resin. When these conventional resin or resin composite balls are exposed to high differential pressures in the wellbore, they tend to fail. Manufacturers therefore may downgrade the pressure rating, of these conventional resin composite balls to account for the increased failures at higher differential pressures. Well-completion companies consequently may use metallic balls that more readily retain their pressure rating and differential pressure capability. However, metal balls, because of their weight, may undesirably fall into deviations in horizontal wellbores where the fluid flow does not adequately act upon them. This sometimes leaves the metal ball stuck in the deviation. The presently disclosed technique is directed to resolving, or at least reducing, one or all of the problems mentioned above.

### SUMMARY

In one aspect, a composite ball for use downhole in a hydrocarbon wellbore includes: a core; a fiber structure arranged around the core, wherein the fiber structure comprises non-uniform oriented fiber; and a resin within and encasing the fiber structure arranged around the core, wherein the composite ball is substantially spherical.

In another aspect, a method for fabricating a composite ball for use downhole in a hydrocarbon wellbore includes: arranging at least one fiber in a plurality of non-uniform orientations around a core; infusing a resin onto the at least one fiber arranged around the core; and forming a resin skin on the composite ball.

In yet another aspect a substantially spherical composite ball for use downhole in a hydrocarbon wellbore is fabricated by a method including: arranging at least one fiber in a plurality of non-uniform orientations around a core; infusing a resin onto the at least one fiber; and forming a resin skin around the resin-infused fiber and the core.

The above presents a simplified summary of the subject matter claimed below in order to provide a basic understanding of some aspects thereof. This summary is not an exhaustive overview. It is not intended to identify key or critical elements or to delineate the scope of the invention. Its sole purpose is to present some concepts in a simplified form as a prelude to the more detailed description that is discussed later.

### BRIEF DESCRIPTION OF THE DRAWINGS

The claimed subject matter may be understood by reference to the following description taken in conjunction with the accompanying drawings, in which like reference numerals identify like elements, and in which:

FIG. 1 is a diagrammatic representation that conceptually illustrates the winding of a fiber about a core in one particular embodiment;

FIG. 2 is a diagrammatic representation that depicts the position of the composite ball in readiness for vacuum deposition of the resin in a particular embodiment;

FIG. 3 is a cross-sectional view of a composite ball of FIG. 1;

FIG. 4 is a diagrammatic representation of a fiber mesh that may be a fiber structure in a composite ball in a particular embodiment;

FIGS. 5A-5E are diagrammatic representations of conceptual illustrations of fiber arranged or applied to a core in manufacturing the composite ball of FIG. 3 in various embodiments;

FIG. 6 is a block flow diagram of a method of manufacturing a composite ball in accordance with embodiments; and

FIG. 7 is a block flow diagram of a method of using the composite ball of FIG. 3 in a well-bore in accordance with embodiments.

While the claimed subject matter is susceptible to various modifications and alternative forms, the drawings illustrate specific embodiments herein described in detail by way of example. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

Illustrative embodiments are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

The presently disclosed technique accommodates the production of hydrocarbons in well-completion activities that may introduce halls into the wellbore, such activities employing balls of various sizes to, for example, seat against tools downhole in the wellbore. Typically, a significant differential pressure, including at relatively high temperatures, may exist across the ball seated in the wellbore within or against the tool. This technique recognizes that conventional composite balls may be susceptible to failure because of the orientation of the reinforcing fiber within the ball relative to the seat in the wellbore.

For instance, when the fibers (e.g., glass) are aligned with the central axis of the seat (e.g., the tensile strength of the fibers and resin support a differential pressure up to about 10,000 psi), the conventional ball may fail in tension when the strength of the resin and fibers are exceeded. When the fibers are transverse to the central axis of the seat (e.g., the tensile strength of the resin supports a differential pressure up to about 7,500 psi), the conventional ball may fail when the tensile strength of the resin is exceeded. Notably, because the seat may be located a relatively long distance downhole and the forces acting on the traveling ball variable, the orientation of the fibers relative to the seat may not be predictable.

Therefore, the presently disclosed technique provides for a non-uniform orientation (e.g., distributed, non-aligned, non-parallel, random, partially random, omnidirectional, not unidirectional, etc.) of the fiber(s) in the composite ball giving improved differential pressure capability, such as with the mechanical properties of the composite ball more isotropic. Thus, unlike conventional composite balls with uniform or aligned fibers, the present composite ball having non-uniform fibers(s) generally does not favor or disfavor a particular placement of the seated composite ball but instead generally accommodates the difficult-to-predict positioning of the ball against the downhole seat that occurs. In other words, the non-uniform fibers may advantageously contribute to mechanical properties of the composite ball that are more isotropic than conventional.

In one particular embodiment, a present composite ball is manufactured having a non-uniform fiber wrap around a core, with a non-uniform or random orientation of the wrap. After the core is wrapped, the partially-completed composite ball is place in a spherical cavity (e.g., mold) having dimensions to give a desired size of the ball. Then, resin is vacuum deposited in the fiber wrap structure around the fibers to substantially or completely fill any voids, and to create a thin skin of resin uniformly around the fiber wrap structure which surrounds the core. After the vacuum deposition of the resin, the skin of the ball may be subjected to further processing such as curing or finishing that removes mold parting lines, and so on.

It is generally more beneficial that the composite ball be more solid rather than less so. This may be accomplished by reducing the number of voids or trapped pockets of air imperfections that may cause the resin to fail prematurely. However, there may be embodiments in which a lesser degree of solidity is acceptable or even advantageous.

Other techniques may be used in addition to or in lieu of vacuum deposition for resin impregnation. For example, in embodiments in which the fiber(s) is/are absorbent, the fiber(s) may alternatively be soaked in the resin and then compressed once the soaked fiber is arranged in non-uniform orientations. Some embodiments may also then be subjected to a vacuum deposition as well. Thus, for example, one approach is to soak the fiber(s) or yarn with resin, compressing the soaked fibers, or vacuum deposition of resin or the fiber(s), or any combination thereof.

Advantageously, because there are non-uniform orientations to the fibers instead of an oriented or flat layup, for example, the fibers may impart improved tensile and compressive characteristics (e.g., more isotropic) of the composite, and which may translate to and provide higher differential pressure capability of the composite ball.

Turning now to the drawings, FIG. 1 conceptually illustrates the process described above. FIG. 1 depicts a step in constructing a composite ball 100 in which a core 105 is wound with a fiber 110. For the sake of clarity, only three windings 115 of the fiber 110 are shown. However, the windings 115 will continue until the ball 100 reaches the desired size. Those in the art having the benefit of this disclosure will appreciate that this will also be a function of the size of the core 105 and tightness of the windings 115.

The windings 115 are applied so that, collectively, they exhibit a non-aligned or non-uniform orientation relative to one another. Greater levels of non-uniformity are generally preferred over lesser degrees. In the illustrated embodiment, each of the windings 115 is offset from the previous winding 115 in angle. The present technique admits wide latitude in how the windings 115 are made and oriented and any unable technique may be used.

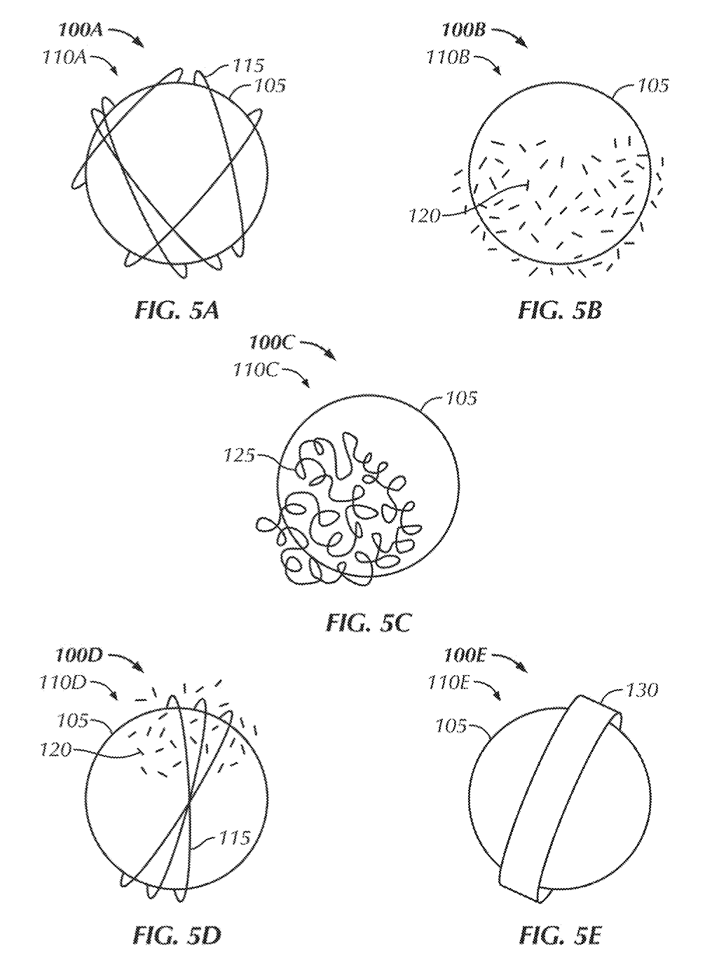

In the illustrated embodiment of FIG. 1, the windings 115 are depicted as providing for a non-uniform fiber structure with a uniform angular offset between the windings 115. Of course, the angular offset between windings may be substantially uniform or to a great extend uniform, as opposed to perfectly uniform. Indeed, as appreciated by one of ordinary skill in the perfect uniformity of the angular oft may be descriptive in theory but m application, some minor or trivial deviations in the uniformity of the angular offsets are to be expected. Moreover, instead of a substantially uniform angular offset, other relationships of the windings are is contemplated to provide a non-uniform fiber structure, such as random windings 115 as depicted in FIG. 5A discussed below.

It is also desirable to achieve a spherical geometry for the windings 115 to facilitate an overall spherical geometry for the composite ball as a whole. Of course, the composite ball may be substantially spherical as opposed to a perfect sphere in that trivial imperfections may exist on the surface of the composite ball, or within the composite ball that contribute to a slight deformity on the surface of the composite ball, and so on. Such minor imperfections may arise from realistic deviations in the molding process of the composite ball, for example. Indeed, as appreciated by one of ordinary skill in the art, a spherical product may be are generally substantially spherical, i.e., to a great extent spherical and not necessarily a perfect sphere.

The core 105 may be constructed of various materials. Exemplary materials from which the core 105 may be fabricated include Bakelite, metal, glass, rubber, and cotton. In general, a material that cat withstand the processing temperature and pressure may be utilized.

The core 105 in the illustrated embodiment is spherical, but this is not necessary to the practice of the invention. The core 105 may exhibit some other geometry provided that the final product shape of the composite ball is spherical. For example, alternative embodiments might employ a “rain drop” or “pear” shape. Such a core could be weighted on one end, which might be advantageous in some applications. However, it may be more difficult to obtain the final shape of a sphere if starting with something other than a spherical core. The composite ball manufactured in accordance with the present disclosure can be spherical even without a spherical core because of the manner in which the resin is infused. The fiber is non-uniform and the winding is not perfectly round, the resin will fill voids and a general spherical cavity of the mold will formulate the shape of the composite ball.

In the case of a spherical core 105, the core 105 may not be a perfect sphere but instead substantially spherical in that imperfections may exist on the surface or within the core 105, for instance. Indeed, as appreciated by one of ordinary skill in the art, spherical components may be generally substantially spherical, i.e., for the most part or essentially spherical, and not necessarily a perfect theoretical sphere.

The fiber 110 may also be constructed of various materials. The fiber 110 may be constructed from the same material as the fibers used in conventional practice. The illustrated embodiment uses fibers made of fiberglass, but alternative embodiments may use other materials that may be made into a filament or yarn. Metal, fiberglass, cotton are a few, but generally material that is pliable and can withstand the processing temperature and pressure may be employed. Note that some of the materials are absorbent to certain kinds of fluids, such as the resin. Note also that, in this particular embodiment, the fiber 110 is generally long enough to complete all the windings 115 without interruption although this is not necessary.

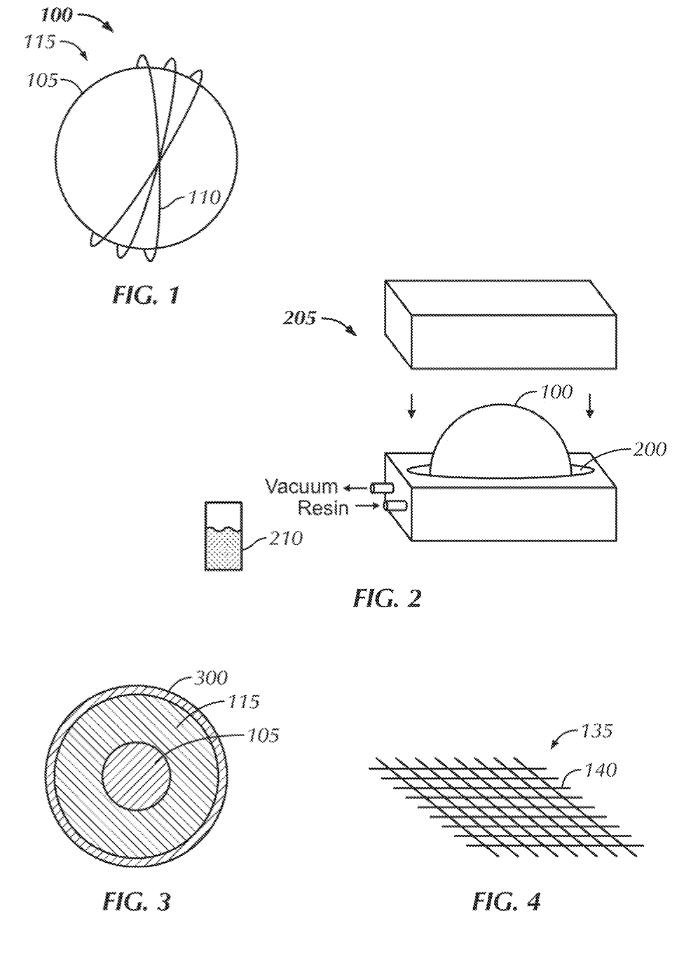

Once the windings 115 are complete, the composite ball 100 is placed in a spherical cavity 200 appropriate to the size of ball desired as is shown in FIG. 2. The cavity 200 is defined by a part mold 205 when the mold 205 is closed as indicated by the arrows. The closed mold 205 encloses the composite ball 100 in the spherical cavity 200. The resin 210 is vacuum deposited in the wrapped fiber(s) 110 (shown in FIG. 1) to fill the voids and create a thin skin 300, best shown in the cross-sectional view of FIG. 3, located uniformly around them. The skin 300 of the composite ball 100 is then finished, by, for example, remove parting lines (not shown). The resin may be any suitable resin known to the art for this purpose, including a phenolic resin, pure phenolic resin, or a thermosetting phenol formaldehyde resin. The resin infusion and finishing may be performed in accordance with techniques used in conventional practice.

The finished product, shown in FIG. 3, is a composite ball 100 including a core 105, wrapped in a non-uniform winding or windings 115 of a resin-infused fiber 110 (shown in FIG. 1) encased in a resin skin 300. In some embodiments, the implementation of the core 105, the windings 115, and the skin 300 is designed to control the overall density of the composite ball 100. Such control may be exerted by, for example, materials selection for the core, winding, and resin; the relative sizes of the core, winding, and skin; or varying combinations of such factors. In some embodiments, the composite ball 100 may have similar tensile and compressive properties along each of its x-axis, y-axis and z-axis, and be isotropic. Moreover, as appreciated by those skilled in the art, the properties may be substantially or essentially the same amongst the axes, as opposed to exactly the same or perfectly identical, or may be substantially (i.e., to a great extent) isotropic as opposed to the theoretical concept of absolutely isotropic.

Embodiments alternative to the fiber windings described above, can be achieved by creating a mesh from a plurality of fibers and compressing the mesh, for example, by approximately 50%, around a core. The compressed mesh and core can then be infused with a resin as described above. In one particular embodiment, the mesh is a wire mesh. However, as with the winding embodiment described above, other suitable materials known to the art may be used in other implementations. FIG. 4 depicts an exemplary mesh 135 having, fibers 140, such as metal or glass fibers, arranged in a perpendicular cross-direction. Of course, other mesh geometries and fiber arrangements may be employed.

Furthermore, in embodiments employing a mesh such as that described immediately above, the mesh can be both the core and the windings when compressed. For example, in one case the mesh is woven similar to a tee shirt or a window screen. It may be to single fiber or multiple fibers. In both cases the ball could be made as a two or three part mechanism. In the first case, it would be a mesh core/winding that was compressed with a resin impregnated into it. In the second case, it would be a mechanism that had a discrete core with compressed mesh for the windings that is impregnated with resin to finish the part. Upon compression, in some embodiments, the fibers of the mesh will take on a non-uniform orientation. This embodiment may also include in some variations a winding or random broken fiber around the outer diameter as in the first case.

The embodiments discussed above all include a core around which at least one fiber is arranged to achieve the non-uniform orientations. The use of such a core is not necessary to the practice of the invention. For example, a fiber may be wound without winding it around a core. Similarly, the mesh in the mesh embodiment described, above can be compressed to a suitable size and shape without the presence of the core.

As for a composite ball in general, the composite may contain fibers that are glass, carbon, wood, metal, filament, and so forth, and which act as a reinforcement and increase mechanical properties of the composite. The polymeric-based matrix of the composite may include thermoset matrices such as phenolic, epoxies, polyesters or vinyl esters. Thermoplastic composites may include resins such as polypropylene, nylon, high density polyethylene, and so on. Advantageously, with the present composite ball, a non-uniform or omnidirectional orientation of the fibers may provide for more isotropic mechanical properties of the composite.

FIG. 5A depicts a fiber structure being applied to the core 105 to form the composite ball. FIG. 5A depicts a similar construction as FIG. 1 but with the fiber 110 having windings 115 more plainly wrapped randomly. While the fiber 110 and windings 115 as applied in FIG. 1 may result in random or near random orientation of the windings relative to one another, FIG. 1 also accommodates a non-uniform orientation that has a uniform angular offset of the windings (as depicted in FIG. 1). Yet, again, FIG. 1 illustrates the general concept of applying non-aligned fiber(s) to provide for a non-aligned orientation and distributed compression and tensile strengths.

FIG. 5E depicts a structure of fiber 110E having a fiber mat or fiber tape 130 wrapped around the core 105 to form the composite ball 100E. While only a single wrap of the fiber tape 130 is depicted in FIG. 5E, multiple wraps of the fiber tape 130 are applied to form the composite ball 100E. The fiber tape 130 may have aligned or unidirectional fibers, or a grid of fibers, or randomly-oriented short or long fibers, and any combination thereof.

As for application of resin, the exemplary fiber structures represented in the foregoing figures (FIG. 1, FIG. 4, FIG. 5A, and FIG. 5E) may be soaked in resin prior to placing the fiber on the core. On the other hand, the fiber structures may be applied resin-free to the core 105 without prior soaking of the fiber with resin. In either case, after application of the fiber structure to the core 105, the fiber-wrapped core may be placed in the mold cavity 200 and resin infused onto and within the fiber structure.

FIGS. 5B-5D depict alternative fiber structures in which short or long fibers may be mixed with resin, and the resin-fiber mixture injected into a mold around a core 105. However, the flow pattern of the injected resin-fiber mixture into the mold may affect orientation of fibers, and thus the resulting non-uniform fiber orientation may not be random or provide for isotropic mechanical properties of the resulting composite ball. Indeed, while a random orientation of the fibers may be realized in the mixture prior to injection, the flow patterns of resin-fiber mixture injected into the mold may provide for non-random orientation of the fibers. Moreover, the amount of resulting anisotropy may be difficult to control. Yet, such resulting orientation may be predicted via modeling, for example. Further, the orientation of the fibers will give a non-uniform fiber and that provides some distribution of the mechanical properties along the three axes.

FIG. 5B depicts forming a structure of fiber 110B including short fibers 120 randomly dispersed around the core 105 to form the composite ball 100B. As indicated, the short fibers 120 may be mixed with resin, and the resin-fiber mixture applied to the core 105 in the mold cavity 200. FIG. 5C depicts forming a structure of fiber 110C including one or more long fibers 125 as a random coil(s) resting on the core 105 to form the composite ball 100C. As with the short fibers, the long fibers 125 may be mixed with resin, and the resin-fiber mixture applied to the core 105 in the mold cavity 200. FIG 5D depicts a structure of fiber 110E having windings 115 (as depicted in FIG. 1) and also having the dispersed short fibers 120 applied in a resin-fiber mixture. Moreover, as indicated by FIG. 5D, two or more of the exemplary fiber structures depicted in the drawings may be combined in forming the composite ball.

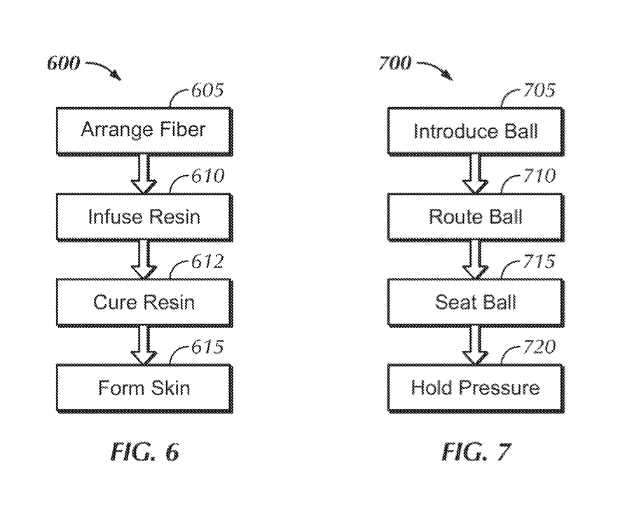

FIG. 6 is an exemplary method 600 of manufacturing a composite ball. Initially, a fiber structure is placed or arranged (block 605) around the core 105. The fiber 110 or fiber structure may include windings 115 of one or more single wound fibers. The windings may be non-uniform in orientation (e.g., non-aligned, non-parallel) relative to each other. The non-uniform windings may have a uniform angular offset or may be random, for example. Further, the fiber 110 structure may include in addition to or in lieu of the windings 115, a compressed mesh 135 of fibers.

With the chosen fiber type and arrangement, the fiber structure is infused (block 610) with resin. Such application of resin to the fiber 110 may include soaking the fiber 110 prior to applying the fiber 110 to the core 105, or infusing resin on and within the fiber 110 structure arranged on the core 105, or a combination thereof. The infusing of resin to the fiber 110 may involve vacuum deposition of the resin onto and within the fiber 110 structure. The resin is then cured (block 612).

Further, a resin skin is formed (block 615) around the fiber structure arranged on the core 105. Such skin may be formed in the vacuum deposition of the resin in block 610, for example, or in other ways. Moreover, the skin of the ball may be subjected to further processing such as finishing that removes mold parting lines, and so on

FIG. 7 is an exemplary method 700 of using a composite ball manufactured via embodiments of the present techniques. The composite ball may be used, for example, in well-completion activities in the production of hydrocarbon. In certain examples, the composite balls may be used to manipulate tools by blocking flow through the tool and by a buildup of pressure, causing movement of one part of the tool in relation to another, for example. Of course, other wellbore downhole tool applications with the composite balls are contemplated. To employ the composite ball, the ball is introduced (block 705) into a wellbore. The composite ball(s) may be initially collected and then introduced by hand, machine, delivery system, within a tool introduced to wellbore, and so on.

The composite ball is routed (block 710) through the wellbore to the position in the wellbore for seating the composite ball. Advantageously, the non-uniform orientation of the fibers in the composite ball may provide for less failure, and accommodate any orientation of the ball relative to the seat in the well-bore. The “routing” of the ball may be by forces or pressures within the wellbore. The composite ball rests or seats (block 715) within or against a surface or mating seat in the wellbore and/or of a corresponding tool installed in the wellbore, for example. The composite ball “holds” (block 720) the wellbore pressure and thus is subjected to a differential pressure.

In sum, the presently disclosed technique provides for a composite ball for use downhole in a hydrocarbon wellbore. The composite ball may include a core and a fiber structure arranged around the core, wherein the fiber structure includes non-uniform oriented fiber. The composite ball includes a resin within and encasing the fiber structure arranged around the core, wherein the core and the composite ball may be substantially spherical. The tensile strengths of the composite ball along each of its x-axis, y-axis, and z-axis may be substantially the same, and the compression strengths of the composite ball along each of its x-axis, y-axis, and z-axis may be substantially the same. The fiber may be at least one single fiber wound around the core, a plurality of fibers in a compressed mesh wrapped and compressed around the core, or a combination thereof. The resin is vacuum-deposited within and on the fiber structure, and wherein the resin encases the arranged fiber structure forming a resin skin around the arranged fiber structure (e.g., as an exterior surface of the composite ball). The core may include Bakelite, metal, glass, rubber, or cotton, or any combination thereof. The fiber may include fiberglass, metal, cotton, polymer, or carbon, or any combination thereof. The resin may be a phenolic resin. As for the core in an alternate embodiment, the compressed mesh may also include the core, or the core may include a plurality of fibers in a compressed mesh.

Also, a method for fabricating a composite ball for use downhole in a hydrocarbon wellbore, includes arranging at least one fiber in a plurality of non-uniform orientations around a core, infusing a resin onto the at least one fiber arranged around the core, and forming a resin skin on the composite ball. The infusing the resin may include infusing the resin by vacuum deposition, and wherein forming the resin skin may include forming the resin skin during the vacuum deposition. The infusing the resin may include soaking the at least one fiber in the resin prior to arranging the at least one fiber around the core. The arranging the at least one fiber may include winding the at least one fiber around the core. In a particular embodiment, the winding the at least one fiber around the core includes wrapping successive windings around the core at a substantially uniform angular offset. In certain embodiments, the at least one fiber includes a plurality of fibers, and wherein arranging the at least one fiber forming a mesh from the plurality of fibers and compressing the mesh around the core.

Therefore, a spherical composite ball for use downhole in a hydrocarbon wellbore may be fabricated by a method including arranging at least one fiber in a plurality of non-uniform orientations around a core, infusing a resin onto the at least one fiber, and forming a resin skin around the resin-infused fiber and the core. Again, the composite ball ma have similar tensile and compressive properties along each of its x-axis, y-axis and z-axis. The at least one fiber may include a single, wound fiber, and arranging the at least one fiber comprises wrapping a fiber around the core in windings having a non-aligned fiber orientation. The fiber may include a plurality of fibers, and wherein wrapping the fiber around the core includes forming a mesh from the plurality of fibers, and compressing the mesh around the core. Lastly, as indicated, infusing the resin may be by vacuum deposition onto the at least one fiber, or by soaking the at least one fiber with the resin, or a combination thereof.

To the extent that any incorporated patent, patent application, or other reference conflicts with the present disclosure, the present disclosure controls.

This concludes the detailed description. The particular embodiments disclosed above are illustrative only, as the claimed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A composite ball for use downhole in a hydrocarbon wellbore, the composite ball comprising:
a core;
a fiber structure arranged around the core, wherein the fiber structure comprises non-uniform oriented fiber; and
a resin within and encasing the fiber structure arranged around the core, wherein the composite ball is substantially spherical.

2. The composite ball of claim 1, wherein the tensile strengths of the composite ball along each of its x-axis, y-axis, and z-axis are substantially the same, and wherein the compression strengths of the composite ball along each of its x-axis, y-axis, and z-axis are the same.

3. The composite ball of claim 1, wherein the core is substantially spherical, and wherein the fiber comprises at least one single fiber wound around the core.

4. The composite ball of claim 1, wherein the fiber structure comprises a plurality of fibers in a compressed mesh wrapped and compressed around the core.

5. The composite ball of claim 4, wherein the compressed mesh also comprises the core.

6. The composite ball of claim 1, wherein the core comprises a plurality of fibers in a compressed mesh.

7. The composite ball of claim 1, wherein the resin is vacuum-deposited within and on the fiber structure, and wherein the resin encases the arranged fiber structure forming a resin skin around the arranged fiber structure as an exterior surface of the composite ball.

8. The composite ball of claim 1, wherein:
the core comprises Bakelite, metal, glass, rubber, or cotton, or any combination thereof;
the fiber comprises fiberglass, metal, cotton, polymer, or carbon, or any combination thereof: and
the resin comprises a phenolic resin.

9. A method for fabricating a composite ball for use downhole in a hydrocarbon wellbore, the method comprising:
arranging at least one fiber in a plurality of non-uniform orientations around a core;
infusing a resin onto the at least one fiber arranged around the core; and
forming a resin skin on the composite ball.

10. The method of claim 9, wherein arranging the at least one fiber comprises winding the at least one fiber around the core.

11. The method of claim 10, wherein winding the at least one fiber around the core comprises wrapping successive windings around the core at a substantially uniform angular offset.

12. The method of claim 9, wherein the at least one fiber comprises a plurality of fibers, and wherein arranging the at least one fiber forming a mesh from the plurality of fibers and compressing the mesh around the core.

13. The method of claim 9, wherein infusing the resin comprises infusing the resin by vacuum deposition, and wherein forming the resin skin comprises forming the resin skin during the vacuum deposition.

14. The method of claim 9, wherein infusing the resin further comprises soaking the at least one fiber in the resin prior to arranging the at least one fiber around the core.

15. A spherical composite ball for use downhole in a hydrocarbon wellbore fabricated by a method comprising:
arranging at least one fiber in a plurality of non-uniform orientations around a core;
infusing a resin onto the at least one fiber; and
forming a resin skin around the resin-infused fiber and the core.

16. The composite ball of claim 15, wherein the composite ball has similar tensile and compressive properties along each of its x-axis, y-axis and z-axis.

17. The composite ball of claim 15, wherein the at least one fiber comprises a single, wound fiber.

18. The composite ball of claim 15, wherein arranging the at least one fiber comprises wrapping a fiber around the core in windings having a non-aligned fiber orientation.

19. The composite ball of claim 15, wherein the fiber comprises a plurality of fibers, and wherein wrapping the fiber around the core comprises forming a mesh from the plurality of fibers, and compressing the mesh around the core.

20. The composite ball of claim 15, wherein infusing the resin comprises infusing the resin by vacuum deposition onto the at least one fiber, or by soaking the at least one fiber with the resin, or a combination thereof.
